(19) United States
(12) Patent Application Publication
(10) Pub. No.: US 2011/0008614 A1
(43) Pub. Date: Jan. 13, 2011

(54) Electrostatic Powder Coatings

(75) Inventors: Tamara Jean Muth, Ballston Lake, NY (US); Patricia Chapman Irwin, Altamont, NY (US); Surinder Singh Pabla, Greer, SC (US); John Drake Vanselow, Taylors, SC (US)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/500,502

(22) Filed: Jul. 9, 2009

(51) Int. Cl. B32B 5/16; B05D 1/04; B05D 1/36; B32B 9/00; B32B 15/04; B32B 18/00; B32B 27/38

(52) U.S. Cl. 428/328; 427/458; 427/470; 428/688; 428/457; 428/702; 428/414

(57) ABSTRACT

In one embodiment, a protective coating may be electrostatically applied to a rotary machine component. The powder coating includes an electrically conductive sacrificial base coat and a ceramic oxide erosion resistant top coat.

### BACKGROUND OF THE INVENTION

The subject matter disclosed herein relates to powder coatings, and more specifically, to electrostatically applied powder coatings employed in rotary machines.

In general, coatings may be employed in rotary machines, such as gas turbines and steam turbines, to inhibit corrosion of rotary machine components. For example, air flowing within the rotary machines may have constituents that are corrosive and/or abrasive. Consequently, a protective coating may be applied to components, such as turbine blades, to protect the components from corrosion. Traditionally, the coatings may be applied using paint spray methods. However, the paint spray coatings may be time consuming and/or expensive to apply. Furthermore, it may be difficult to obtain a uniform coating, particularly for areas of complex shapes and/or sizes.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a rotary machine component and an electrostatically applied powder coating disposed on the rotary machine component. The powder coating includes an electrically conductive sacrificial base coat and a ceramic oxide erosion resistant top coat.

In a second embodiment, a method for applying a protective coating includes electrostatically applying ceramic oxide particles dispersed in a binder to a rotary machine component to form an erosion resistant coating and curing the erosion resistant coating to suspend the ceramic oxide particles in a matrix of the binder.

In a third embodiment, a method for applying a protective coating includes electrostatically applying a mixture of metal particles fed into a spray gun at a first feed rate and ceramic particles fed into a spray gun at a second feed rate to a rotary machine component to form a protective coating, adjusting the first feed rate and/or the second feed rate to apply a sacrificial layer to the rotary machine component, and adjusting the first feed rate and/or the second feed rate to electrostatically apply an erosion resistant layer to the sacrificial layer. The sacrificial layer includes more metal particles than ceramic particles, and the erosion resistant layer includes more ceramic particles than metal particles.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an embodiment of a combined cycle power generation system that may employ electrostatically applied coatings;

FIG. 2 is a schematic diagram of an embodiment of an electrostatic spray system that may be employed to apply powder coatings;

FIG. 3 is a flow chart of an embodiment of a method for electrostatically applying a powder coating;

FIG. 4 is a flow chart of an embodiments of a method for electrostatically applying a powder coating in two layers; and

FIG. 5 is a flow chart of an embodiment of a method for electrostatically applying a powder coating over a painted layer.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to electrostatically applied powder coatings for rotary machines. The powder coatings may be used to protect components of the rotary machines from aqueous corrosion, particle erosion, slurry erosion, fretting, and/or fouling, among others. The power coatings may generally be applied to a substrate in at least two layers, e.g., an inner sacrificial layer and an outer erosion resistant layer. The sacrificial layer may be an electrically conductive and galvanically (i.e. cathodic) sacrificial coating with a high metal content that is designed to preferentially corrode, thereby protecting the substrate. The erosion resistant layer may be a ceramic oxide coating designed to resist erosion and retard sacrificial consumption of the sacrificial layer.

Rather than applying the powder coating through a paint spray or thermal spray process, one or more of the sacrificial layer and the erosion resistant layer may be electrostatically applied. The electrostatic application may provide enhanced coating thickness and coverage by reducing the need for a “line of sight” process. Specifically, the electrostatic application uses charged particles that are attracted to the substrate, facilitating coverage in areas that have complex shapes, sizes, and/or limited visibility. Moreover, the electrostatic application may be easier and faster to apply than a paint spray or thermal spray process.

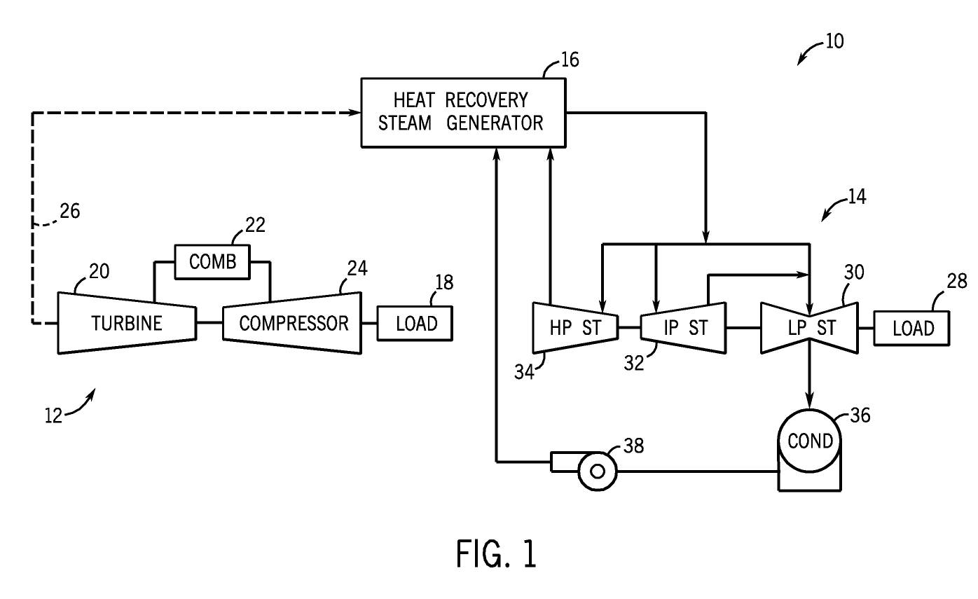

FIG. 1 is a schematic flow diagram of an embodiment of a combined cycle power generation system 10 that may employ electrostatically applied powder coatings. The system 10 may include a gas turbine 12, a steam turbine 14, and a heat recovery steam generation (HRSG) system 16. Within the gas turbine 14, gas, such as syngas, may be combusted to generate power within a “topping,” or Brayton, cycle. Exhaust gas from the gas turbine 14 may be supplied to the HRSG system 16 to generate steam within a “bottoming,” or Rankine, cycle. In certain embodiments, the gas turbine 12, the steam turbine 14, and the HRSG system 16 may be included within an integrated gasification combined cycle (IGCC) power plant.

The gas turbine 12 may generally combust a fuel (e.g., liquid and/or gas fuel) to drive a first load 18. The first load 18 may, for instance, be an electrical generator for producing electrical power. The gas turbine 12 may include a turbine 20, a combustor or combustion chamber 22, and a compressor 24. Exhaust gas 26 from the gas turbine 20 may be used to generate steam supplied to steam turbine 14 (through the HRSG system 16) for driving a second load 28. The second load 28 also may be an electrical generator for generating electrical power. However, both the first and second loads 18 and 28 may be other types of loads capable of being driven by the gas turbine 12 and steam turbine 14. Further, although the gas turbine 12 and steam turbine 14 are depicted as driving separate loads 18 and 28, the gas turbine 12 and steam turbine 14 also may be utilized in tandem to drive a single load via a single shaft. In the illustrated embodiment, the steam turbine 14 may include one low-pressure section 30 (LP ST), one intermediate-pressure section 32 (IP ST), and one high-pressure section 34 (HP ST). However, the specific configuration of the steam turbine 14, as well as the gas turbine 12, may be implementation-specific and may include any combination of sections.

The system 10 also includes the HRSG system 16 for employing heat from the gas turbine 12 to generate steam for the steam turbine 14. The HRSG system 16 may include components such as evaporators, economizers, heaters, superheaters, and attemperators, among others, that are used to generate a high-pressure, high-temperature steam. The steam produced by the HRSG system 16 may be supplied to the low-pressure section 30, the intermediate pressure section 32, and the high-pressure section 34 of the steam turbine 14 for power generation. Exhaust from the low-pressure section 30 may be directed into a condenser 36. Condensate from the condenser 36 may, in turn, be returned to the HRSG system 16 with the aid of a condensate pump 38. Within the HRSG system 16, the condensate may then be reheated to generate steam for the steam turbine 14.

The electrostatically applied powder coatings may be applied as protective coatings to one or more components within the combined cycle system 10. For example, the powder coatings may be applied to blades of the gas turbine 20, the compressor 24, and/or the steam turbine 14. Moreover, the powder coatings may be employed in other types of rotary machines, such as wind turbines and hydro turbines.

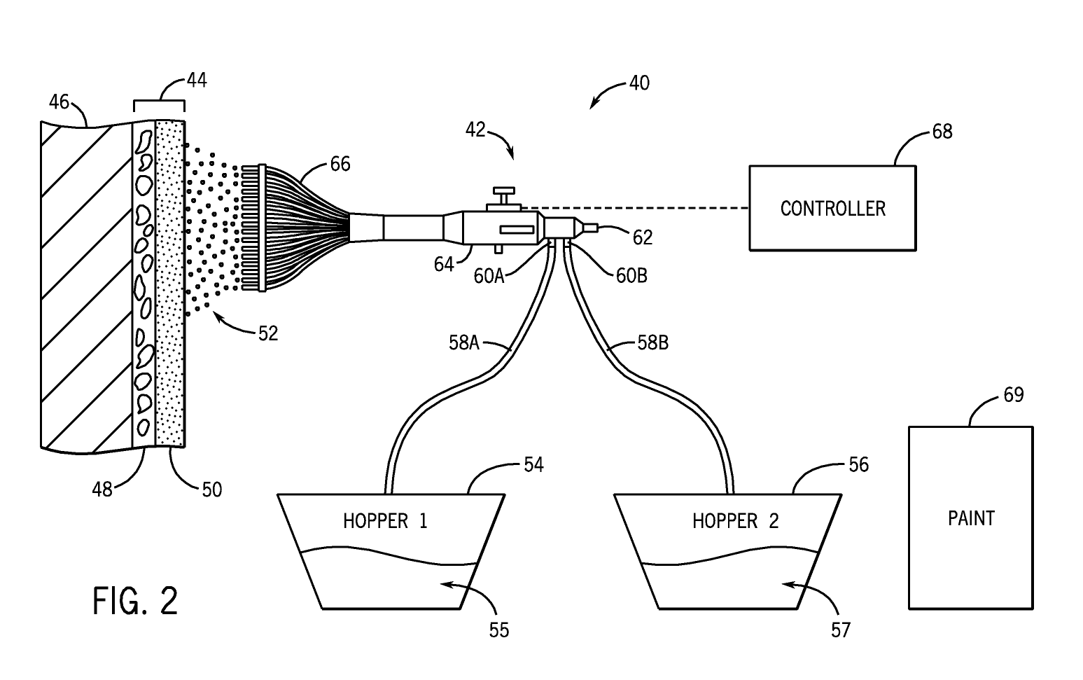

FIG. 2 depicts an embodiment of an electrostatic spray system 40 that may be used to apply powder coatings to components of a rotary machine. The electrostatic spray system 40 includes one or more spray guns 42 that are used to apply a powder coating 44 to a substrate 46. The powder coating 44 may generally be designed to protect the substrate 46 from corrosion, such as heat oxidation corrosion and/or salt corrosion. The powder coating 44 may be designed to withstand temperatures greater than or equal to approximately 150 degrees C. In certain embodiments, the powder coating 44 may be designed to provide sacrificial properties and to protect against high temperature, heat oxidation up to temperatures of approximately 650 degrees C. Moreover, the powder coating 44 may be substantially inorganic, for example, having approximately 0 to 10 percent by weight of organic components. Moreover, in certain embodiments, the powder coating 44 may have at least less than approximately 10, 9, 8, 7, 6, 5, 4, 3, 2, or 1 percent by weight of organic components. The powder may generally include metal particles and ceramic particles, as well as other components, such as binder, fillers, pigments, additives, or combinations thereof, among others.

The substrate 46 may include components of a gas turbine engine, steam turbine engine, or the like, for example such as gas turbine blades, compressor blades, or steam turbine blades, among others. According to certain embodiments, the substrate 46 may be a metal or metal alloy, such as stainless steel. The substrate 46 may be prepared for the electrostatic application by cleaning and/or roughening, for example by dry grit blasting or vapor blasting.

The one or more spray guns 42 may be used to electrostatically apply a portion or all of the powder coating 44 to the substrate. Specifically, the powder coating 44 includes an inner sacrificial layer 48 disposed on the substrate 46 an outer erosion resistant layer 50 disposed on the sacrificial layer 48. The sacrificial layer 48 is a layer designed to preferentially corrode. The sacrificial layer 48 may be painted, for example by paint spraying or thermal spraying, or may be electrostatically applied to the substrate 46 using the spray gun 42. The sacrificial layer 48 may have a high metal content and may be electrically conductive to provide sacrificial properties. For example, the sacrificial layer 48 may be an aluminum rich layer designed to preferentially corrode if the erosion resistant layer 50 is breached. According to certain embodiments, the sacrificial layer 48 may have a thickness of approximately 50-100 microns, and all subranges therebetween. However, in other embodiments, the thickness may vary.

The erosion resistant layer 50 may be electrostatically applied to the sacrificial layer 48 using the spray gun 42. The erosion resistant layer 50 may be designed to protect the sacrificial layer 48 by retarding sacrificial consumption of the sacrificial layer 48. For example, the erosion resistant layer 50 may include ceramic oxide particles designed to fill in micropores of the sacrificial layer 48. According to certain embodiments, the erosion resistant layer 50 may have a thickness of approximately 50-250 microns, and all subranges therebetween. However, in other embodiments, the thickness may vary.

Moreover, the ratio of the sacrificial layer 48 to the erosion resistant layer 50 may vary. According to certain embodiments, the powder coating 44 may include approximately 50% by weight of the sacrificial layer 48 and approximately 50% by weight of the erosion resistant layer 50. However, in other embodiments, the powder coating 44 may include approximately 30 to 50 percent by weight of the sacrificial layer 48 and approximately 50 to 70 percent by weight of the erosion resistant layer 50.

One or both of the layers 48 and 50 may be electrostatically applied using the spray gun 42. Specifically, the spray gun 42 may direct charged particles 52 towards the substrate 46 to electrostatically apply the power coating 44. The spray gun 42 may include a triboelectric spray gun, a corona charged spray gun, or other suitable electrostatic spray gun. Further, the spray gun 42 may be manually operated, for example, by an operator, or an automated process may be employed.

The spray gun 42 may receive the particles for the powder coating 44 from hoppers 54 and 56. Specifically, the first hopper 54 may contain a metal rich powder 55 designed to provide galvanically sacrificial properties for the sacrificial layer 48, and the second hopper 56 may contain a ceramic oxide powder 57 designed to provide erosion resistant properties for the erosion resistant layer 50. The metal rich powder 55 may include at least more than approximately 50 percent by weight of metallic components. More specifically, the metal rich powder 55 may include at least more than approximately 80 percent by weight of metallic components. The powders 55 and 57 may generally be prepared by blending components and processing the components by heating and milling to form an extruded blended mass that is cooled, and crushed into small chips or lumps and then ground into powder.

In certain embodiments, the metal rich powder 55 may include aluminum spheres or flakes disposed in a phosphate chromate binder mixture. According to certain embodiments, the metal rich powder 55 may include approximately 0.5 to 5.0 percent by weight of aluminum particles with a median particle size of approximately 30 to 50 microns and an aspect ratio of approximately 1:1 to 1:5. In these embodiments, the aluminum particles may be dispersed in a volatile organic binder. In other embodiments, the metal rich powder 55 may include approximately 25-50 percent by volume of aluminum particles with a median particle size of approximately 25-50 microns and an aspect ratio of approximately 1:1 to 1:5. In these embodiments, the aluminum particles may be dispersed in a phosphate chromate binder mixture.

In certain embodiments, the erosion resistant powder 57 may include flat or round ceramic oxide particles disposed in an inorganic phosphate binder or in an organic epoxy binder. According to certain embodiments, the erosion resistant powder 57 may include approximately 50 to 80 weight percent of alumina particles with a median particle size of approximately 10 to 50 microns. However, in other embodiments, the ceramic oxide particles may include alumina, titania, chromia, silica, zirconia, yttria, or combinations thereof. For example, the ceramic oxide particles may include alumina, chromia, a mixture of alumina and titania, a mixture of chromia and silica, a mixture of chromia and titania, a mixture of chromia, silica, and titania, or a mixture of zirconia, titania, and yttria.

The phosphate binder may include phosphoric acid, and/or phosphate compounds, such as orthophosphates, pyrophosphates, or metal phosphates, such as aluminum phosphates, magnesium phosphates, chromium phosphates, zinc phosphates, iron phosphates, lithium phosphates, calcium phosphates, or combinations thereof. In other embodiments, the binder may include an inorganic epoxy polyester binder, such as a thermoset epoxy. According to certain embodiments, the binder may be Alseal 598, commercially available from Coatings For Industry, Inc., of Souderton, Pa.

To electrostatically apply the powder coating 44, the powders 55 and 57 may be directed through hoses 58A and 58B to respective inlets 60A and 60B of the spray gun 42. In addition to the powders 55 and 57, the spray gun 42 may receive air through an inlet 62. The spray gun 42 may mix the air with the powder, and direct the air and powder mixture through a charging section 64 of the spray gun 42. Within the charging section 64, the powders may be charged to form the charged particles 52 that are directed through a spray head 66 and onto the substrate 46.

A controller 68 may be connected to the spray gun 42 to vary the feed rates of the powders 55 and 57 entering the spray gun 42. The controller 68 may include control circuitry and components, such as an analog to digital convert, a microprocessor, a non volatile memory, and an interface board, among other components. The controller 68 may be designed to vary the feed rates based on factors such as application times, look up tables, or operator inputs, among others. Moreover, in certain embodiments, the controller 68 may be omitted and the feed rates may be adjusted manually.

In certain embodiments, the sacrificial layer 48 may be applied using only the powder 55 within the first hopper 54 while the erosion resistant layer 50 may be applied using only the powder 57 within the second hopper 56. However, according to certain embodiments, each of the layers 48 and 50 may be applied using a mixture of both powders 55 and 57. In these embodiments, the ratios of the powders 55 and 57 in each of the layers 48 and 50 may vary. For example, the sacrificial layer 48 may be applied by directing a mixture of approximately 95 percent of the powder from the first hopper 54 and 5 percent of the powder from the second hopper 56 through the spray gun 42 to the substrate 46. As the first layer develops, the controller 68 may adjust the feed rates of the powders 55 and 57 to vary the ratio between the powders 55 and 57 gradually or incrementally throughout the layer 48. In other words, the layer 48 may include continuous and/or stepwise transitions between different rations between the powders 55 and 57. Moreover, in certain embodiments, the layer 48 may include sub layers, with each sub layer including different ratios between the powders (e.g., 95/5, 90/10, 85/15, 80/20, etc.). In certain embodiments, the controller 68 may adjust feed rates of the powders 55 and 57 to gradually change the ratio of the sacrificial powder 55 to the erosion resistant powder 57 from approximately 95:5 to 50:50, and all subranges therebetween. However, in other embodiments, the sacrificial layer 48 may be applied using a constant ratio between the sacrificial powder 55 and the erosion resistant powder 57.

Once the sacrificial layer 48 is applied, the erosion resistant layer 50 may be applied using the spray gun 42. In certain embodiments, the sacrificial layer 48 may be cured and/or tested prior to application of the erosion resistant layer 50. For example, the sacrificial layer may be glass bead blasted with alumina to consolidate the aluminum particles into a continuous sheet designed to provide electrical conductivity. However, in other embodiments, no additional curing and/or testing may be employed between the layers 48 and 50. In these embodiments, the erosion resistant layer 50 may be applied directly after application of the sacrificial layer 48.

As noted above, in certain embodiments, the erosion resistant layer 50 may be applied using only the powder 57 within the second hopper 56. However, according to certain embodiments, the erosion resistant layer 50 may be applied using a mixture of both powders 55 and 57. For example, the sacrificial layer 50 may be initially applied by directing a mixture of approximately 50 percent of the powder 55 from the first hopper 54 and approximately 50 percent of the powder 57 from the second hopper 56 through the spray gun 42 to the substrate 46. As the erosion resistant layer 50 develops, the controller 68 may adjust the feed rates of the powders 55 and 57 to vary the ratio between the powders 55 and 57 gradually or incrementally throughout the layer 48. In other words, the layer 50 may include continuous and/or stepwise transitions between different ratios between the powders 55 and 57. Moreover, in certain embodiments, the layer 50 may include sub layers, with each sub layer including different ratios between the powders (e.g., 50/50, 45/55, 40/60, 35/65, etc.). In certain embodiments, the controller 68 may adjust feed rates of the powders 55 and 57 to gradually change the ratio of the sacrificial powder 55 to the erosion resistant powder 57 from approximately 50:50 to 5:95, and all subranges therebetween. However, in other embodiments, the erosion resistant layer 50 may be applied using a constant ratio between the sacrificial powder 55 and the erosion resistant powder 57.

Furthermore, in certain embodiments, the controller 68 may adjust the feed rates to apply the sacrificial layer 48 and the erosion layer 50 in a single step. In these embodiments, the powder coating 44 may gradually transition from the sacrificial layer 48 to the erosion resistant layer 50. That is, the layers 48 and 50 may transition gradually from one layer 48 to the other layer 50 such that no separation is present between the layers 48 and 50.

After the powder coating 44 has been applied, the powder coating 44 may be cured. For example, the powder coating 44 may be exposed to elevated temperature to promote chemical reactions within the erosion resistant layer 50 to form an amorphous glass phase that suspends the ceramic oxide particulates within the binder.

In certain embodiments, the sacrificial layer 48 may be painted, such as spray painted or thermally sprayed, instead of electrostatically applied. In these embodiments, the sacrificial layer 48 may be created by applying a paint mixture 69, such as an aluminum particle slurry, to the substrate 46. The paint mixture 69 may include aluminum particles in a phosphate and dichromate liquid binder. However, in other embodiments, any suitable binder that does not impede electrical conductivity may be employed. In certain embodiments, the paint mixture 69 may generally include 50 to 25 percent by volume of aluminum flakes with a median particle size of approximately 25 to 50 microns and an aspect ratio of 1:1 to 1:5. For example, the paint mixture 69 may include Alseal 519, commercially available from Coatings For Industry, Inc., of Souderton, Pa. However, in other embodiments, any suitable aluminum rich ceramic coating may be employed.

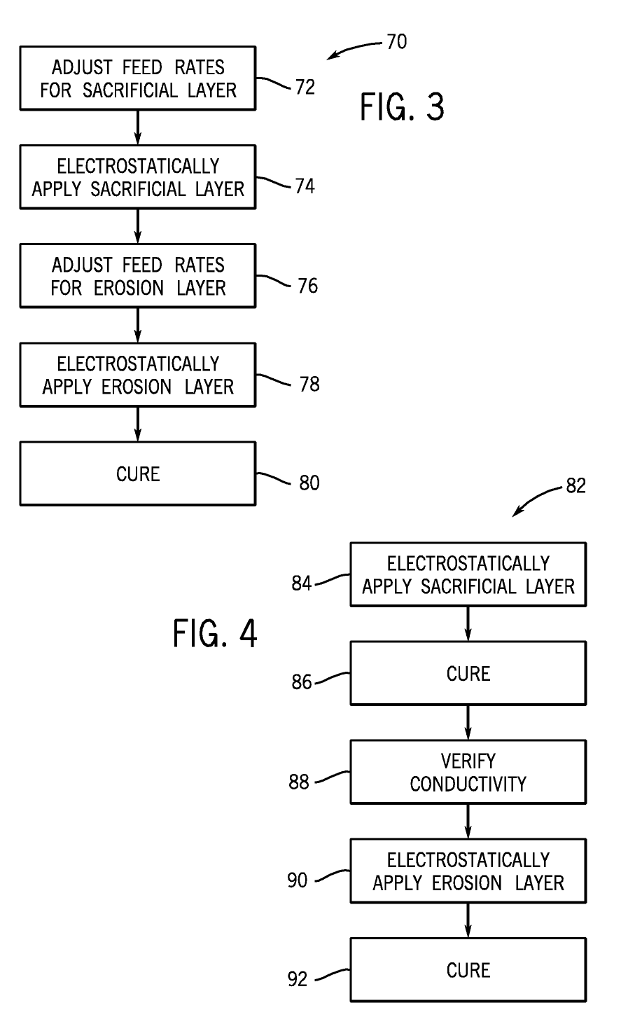

FIG. 3 depicts an embodiment of a method 70 for electrostatically applying the powder coating 44 (FIG. 2). In this method, both the sacrificial layer 48 (FIG. 2) and the erosion resistant layer 50 (FIG. 2) may be electrostatically applied. The method 70 may begin by adjusting (block 72) spray gun feed rates for the sacrificial layer 48. For example, the controller 68 (FIG. 2), may set the spray gun 42 to receive more sacrificial powder 55 (FIG. 2) than erosion resistant powder 57 (FIG. 2). In certain embodiments, the controller 68 may set the spray gun 42 to receive approximately 95 percent sacrificial powder 55 and approximately 5 percent erosion resistant powder 57.

The spray gun 42 may then be used to electrostatically apply (block 74) the sacrificial layer 48. In certain embodiments, the ratios between the powders 55 and 57 may remain constant as the sacrificial layer 48 is applied. Moreover, in certain embodiments, the spray gun 42 may receive 100 percent of the sacrificial powder 55 when applying the sacrificial layer 48. However, in other embodiments, the respective amount of each of the powders 55 and 57 may be incrementally or gradually adjusted as the layer 48 is applied to the substrate 46. In certain embodiments, the controller 68 adjusts the feed rates from an initial ratio of approximately 95 percent sacrificial powder 55 to approximately 5 percent erosion resistant powder 57 to a ratio of approximately 50 percent sacrificial powder 55 to approximately 50 percent erosion resistant powder 57.

After the first layer 48 is applied, the controller 68 may adjust (block 76) the spray gun feed rates for the erosion resistant layer 50. For example, the controller 68 (FIG. 2), may set the spray gun 42 to receive more erosion resistant powder 57 than sacrificial powder 55. In certain embodiments, the erosion coating 50 may be initially applied using approximately 50 percent of the sacrificial powder 55 and approximately 50 percent of the erosion resistant powder 57.

The spray gun may then be used to electrostatically apply (block 78) the erosion coating layer 50. In certain embodiments, the ratios between the powders 55 and 57 may remain constant as the erosion resistant layer 50 is applied. Moreover, in certain embodiments, the spray gun 42 may receive 100 percent of the erosion resistant powder 57 when applying the sacrificial layer 48. However, in other embodiments, the respective amount of each of the powders 55 and 57 may be incrementally or gradually adjusted as the layer 50 is applied. In certain embodiments, the controller 68 may adjust the feed rates from an initial ratio of approximately 50 percent sacrificial powder 55 to approximately 50 percent erosion resistant powder 57 to a ratio of approximately 5 percent sacrificial powder 55 to approximately 95 percent erosion resistant powder 57.

After the erosion resistant layer 50 is applied, the powder coating 44 may be cured (block 80). For example, the powder coating 44 may be cured for approximately 60 minutes at a temperature of 250 to 815° C. However in other embodiments, the curing times, temperatures, and/or methods may vary. The curing may be designed to harden the powder coating 44 and/or to provide erosion resistance. In certain embodiments, the hardened powder coating 44 may be designed to resist corrosion. For example, the hardened powder coating 44 may be subjected to the salt fog test specified in ASTM B117-07a for 227 hours and there may be no corrosion of the substrate 46. Moreover, in certain embodiments, the curing may volatilize components of the binder in the sacrificial layer 48 and/or may promote chemical reactions within the erosion resistant layer 50 to suspend the ceramic particles within the binder.

FIG. 4 depicts an embodiment of a method 82 for electrostatically applying the powder coating 44 where the sacrificial layer 48 is cured and tested prior to application of the erosion resistant layer 50. The method 82 may begin by electrostatically applying (block 84) the sacrificial layer 48. For example, the spray gun 42 may be used to apply the sacrificial powder 55 included within the first hopper 54 to the substrate 46. In certain embodiments, the sacrificial layer may include approximately 100 percent of the sacrificial powder 55. However, in other embodiments, the sacrificial layer 48 may include graduated ratios (e.g., 95/5, 90/10, 85/15, 80/20, etc.) of the sacrificial powder 55 to the erosion resistant powder 57, as described above with respect to FIG. 3.

After the sacrificial layer 48 has been applied, the layer may be cured (block 86). For example, the layer may be burnished by glass peening to consolidate the aluminum particles into a continuous sheet to provide an electrically conductive coating. In another example, the sacrificial layer 48 may be post cured, for example, by heating the sacrificial layer 48 for approximately 60 minutes at approximately 260 to 815° C. In other embodiments, the curing times and/or temperatures may vary. For example, the sacrificial layer 48 may be post cured by heating the sacrificial layer 48 for approximately 20 minutes at 200° C. or by heating the sacrificial layer 48 for approximately 10 minutes at 340° C.

After curing, the conductivity of the sacrificial layer 48 may be verified (block 88). For example, the conductivity may be verified by using light pressure with probes of an ohm meter held at approximately 2.54 centimeters apart to obtain an ohm reading less than or equal to approximately 10 ohms. After the conductivity has been verified, the method may continue by electrostatically applying (block 90) the erosion resistant layer 50. For example, the erosion resistant powder 57 may be electrostatically applied to form the erosion resistant layer 50 shown in FIG. 2. In certain embodiments, the erosion resistant layer 50 may be a generally uniform layer including approximately 100 percent of the erosion resistant powder 57. However, in other embodiments, the erosion resistant layer 50 may include graduated ratios (e.g., 50/50, 45/55, 40/60, 35/65, 30/70, etc.) of the sacrificial powder 55 to the erosion resistant powder 57, as described above with respect to FIG. 3.

After the erosion resistant layer 50 has been applied, the erosion resistant layer 50 may be cured (block 92). For example, the erosion resistant layer 50 may be cured by heating the layer for approximately 60 minutes at approximately 260 to 815 degrees C. However, in other embodiments, the curing times, temperatures, and/or methods may vary. In certain embodiments, the curing may allow the erosion layer 50 to harden.

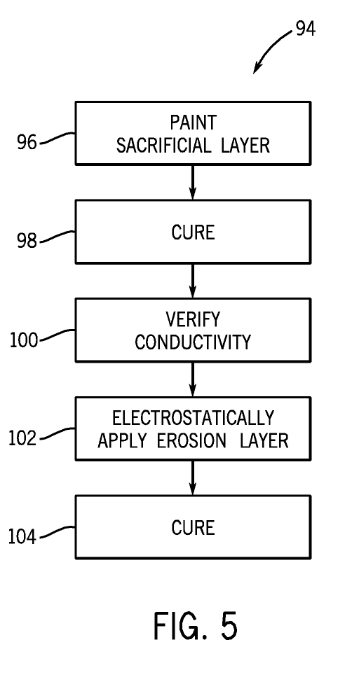

FIG. 5 depicts a method 94 for applying the powder coating using both a painting application process and an electrostatic application process. The method 94 may begin by painting (block 96) the sacrificial layer 48 onto the substrate 46. For example, the paint mixture 69 shown in FIG. 1 may be spray painted or thermally sprayed onto the substrate 46. In certain embodiments, the sacrificial layer 48 may be applied to a thickness of approximately 50 microns.

After application, the sacrificial layer 48 may be cured (block 98). For example, by post curing at approximately 552° C. for approximately 60 minutes, or by burnishing the coating by glass bead peening or by using aluminum oxide. In certain embodiments, the curing may include glass bead blasting the layer with alumina to consolidate the aluminum particles into a continuous sheet providing electrical conductivity. The conductivity may then be verified (block 100), for example, using an ohm meter. In certain embodiments, ohm meter probes may be applied to the sacrificial layer 48 with light pressure and held approximately 1 inch apart to obtain a reading of less that or equal to approximately 10 ohms.

After the conductivity has been verified, the method may continue by electrostatically applying (block 102) the erosion resistant layer. For example, the spray gun 42 of FIG. 2 may be used to apply the erosion resistant powder 57 to the substrate 46. In certain embodiments, the erosion resistant layer 50 may include 100 percent of the erosion resistant powder 57. However, in other embodiments, the erosion resistant layer 50 may include graduated ratios of the sacrificial powder 55 to the erosion resistant powder 57, as described above with respect to FIG. 3. After the erosion layer has been applied, the layer may be cured (block 104). For example, the layer may be cured by baking the layer for 60 minutes at approximately 260 to 815 degrees C. However, in other embodiments, the curing times, temperatures, and/or methods may vary.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a rotary machine component; and
an electrostatically applied powder coating disposed on the rotary machine component, the powder coating comprising:
an electrically conductive sacrificial base coat; and
a ceramic oxide erosion resistant top coat.

2. The system of claim 1, wherein the electrically conductive sacrificial base coat comprises aluminum particles disposed in a volatile organic binder.

3. The system of claim 1, wherein the electrically conductive sacrificial base coat comprises approximately 0.5 to 5.0 percent by volume of aluminum flakes with a median particle size of approximately 30 to 50 microns disposed in a volatile organic binder.

4. The system of claim 1, wherein the electrically conductive sacrificial base coat comprises approximately 25 to 50 percent by volume of aluminum flakes with a median particle size of approximately 25 to 50 microns disposed in an inorganic binder.

5. The system of claim 1, wherein the ceramic oxide erosion resistant top coat comprises ceramic particles disposed in a phosphate binder.

6. The system of claim 5, wherein the ceramic particles comprise alumina, titania, chromia, silica, zirconia, yttria, or combinations thereof.

7. The system of claim 5, wherein the phosphate binder comprises a phosphoric acid, an aluminum phosphate, a magnesium phosphate, a chromium phosphate, a zinc phosphate, an iron phosphate, a lithium phosphate, a calcium phosphate, or combinations thereof.

8. The system of claim 5, wherein the ceramic oxide erosion resistant top coat comprises ceramic particles disposed in a thermoset epoxy binder.

9. The system of claim 1, wherein the powder coating withstands temperatures of at least approximately 150 degrees Celsius.

10. The system of claim 1, wherein the powder coating comprises at least less than approximately 10 percent by weight of organic material.

11. The system of claim 1, wherein the rotary machine component comprises gas turbine blades, steam turbine blades, or compressor blades.

12. A method for applying a protective coating, the method comprising:
electrostatically applying ceramic oxide particles dispersed in a binder to a rotary machine component to form an erosion resistant coating; and
curing the erosion resistant coating to suspend the ceramic oxide particles in a matrix of the binder.

13. The method of claim 12, comprising:
applying a metal rich coating to the rotary machine component; and
curing the metal rich coating to form an electrically conductive sacrificial base coat;
wherein electrostatically applying ceramic oxide particles comprises disposing the ceramic oxide particles on the electrically conductive sacrificial base coat.

14. The method of claim 13, wherein applying the metal rich coating comprises electrostatically applying aluminum particles to the rotary machine component.

15. The method of claim 13, wherein applying the metal rich coating comprises painting an aluminum coating on the rotary machine component.

16. The method of claim 12, wherein electrostatically applying ceramic oxide particles comprises applying a mixture of ceramic oxide particles and metallic particles.

17. A method for applying a protective coating, the method comprising:
electrostatically applying a mixture of metal particles fed into a spray gun at a first feed rate and ceramic particles fed into a spray gun at a second feed rate to a rotary machine component to form a protective coating;
adjusting the first feed rate and/or the second feed rate to apply a sacrificial layer to the rotary machine component, wherein the sacrificial layer comprises more metal particles than ceramic particles; and
adjusting the first feed rate and/or the second feed rate to electrostatically apply an erosion resistant layer to the sacrificial layer, wherein the erosion resistant layer comprises more ceramic particles than metal particles.

18. The method of claim 17, comprising curing the protective coating.

19. The method of claim 17, wherein adjusting the first feed rate and/or the second feed rate to apply the sacrificial layer comprises varying the first feed rate and/or the second feed rate to incrementally adjust a ratio of the metal particles fed into the spray gun to the ceramic particles fed into the spray gun from approximately 95:5 to 50:50.

20. The method of claim 17, wherein adjusting the first feed rate and/or the second feed rate to apply the erosion resistant layer comprises varying the first feed rate and/or the second feed rate to incrementally adjust a ratio of the metal particles fed into the spray gun to the ceramic particles fed into the spray gun from approximately 50:50 to 5:95.
